(19) United States
(12) Patent Application Publication
(10) Pub. No.: US 2023/0158838 A1
(43) Pub. Date: May 25, 2023

(54) TIRE

(71) Applicant: The Goodyear Tire & Rubber Company, Akron, OH (US)

(72) Inventors: Thomas Egon Baumann, Aschaffenburg (DE); Roman Goerl, Obernburg am Main (DE); Selcuk Ata, Freigericht (DE); Viktor Pranas Vogel, Alsbach-Haehnlein (DE); Helmut Wolfgang Fehl, Schluechtern (DE); Ümit Bilmez, Hanau (DE)

(21) Appl. No.: 18/050,538

(22) Filed: Oct. 28, 2022

Related U.S. Application Data
(60) Provisional application No. 63/264,297, filed on Nov. 19, 2021.

(51) Int. Cl. B60C 15/06; B60C 1/00; B60C 3/04

(52) U.S. Cl. CPC B60C 15/06; B60C 1/0041; B60C 3/04; B60C 2015/0614; B60C 2013/007

(57) ABSTRACT

The present invention is directed to a tire comprising a tread, two sidewalls, a carcass and at least two belts arranged radially between the carcass and the tread in a crown area of the tire. The tread has at least one axially outer edge portion covering the axially outermost edge of at least one of the belts and comprising a different rubber composition than a portion of the tread neighboring the axially outer edge portion of the tread. Furthermore, one of the sidewalls at least partially covers and contacts the axially outer surface of the axially outer edge portion of the tread.

### FIELD OF THE INVENTION

The present invention relates to a tire, in particular a pneumatic tire.

### BACKGROUND OF THE INVENTION

High performance tires have superior driving properties compared to conventional tires. However, apart from advanced driving performance, it is also important that such tires are sufficiently endurant. In particular, they should withstand forces and heat over long periods of time and in some cases also under high loads.

While many improvements have been made in this area over the past decades, significant room for improving tire endurance properties remains.

### SUMMARY OF THE INVENTION

One object of the present invention may be to provide an advanced tire with improved endurance properties.

Another object of the present invention may be to provide an advanced tire with a sidewall over tread design or construction, having advanced endurance properties under conditions where the tire is used on a vehicle which is driven at high speeds.

Another object of the present invention may be to provide an advanced tire with a reduced heat built-up in the belt edge area of the tire.

Another object of the present invention is to provide a high performance (HP), ultra-high performance (UHP), ultra-ultra-high performance (UUHP) or race tire with advanced endurance properties.

The scope of protection of the present invention is defined by independent claim 1. Further preferred embodiments are provided in the dependent claims and the summary of the invention herein below.

Thus, in a first aspect of the invention, the present invention is directed to a tire comprising a tread, two sidewalls, a carcass and at least two belts (or, in other words, belt plies) arranged radially between the carcass and the tread, preferably in a crown area of the tire. The tread has at least one axially outer edge portion (or axially outer portion) radially covering the axially outermost edge of at least one of the belts and comprising a different rubber composition than a neighboring portion of the tread, wherein the neighboring portion of the tread is intended to contact the ground (or road) when driving. Moreover, one of the sidewalls (or a respective sidewall) at least partially covers and contacts the axially outer surface of the axially outer edge portion of the tread.

In such a design, the sidewall covers the tread, which is also sometimes referred to as a sidewall over tread design or construction. The design according to the present invention is of particular advantage as the axially outer edge portion of the tread covers at least one axially outer belt edge, in particular with a rubber compound different than the rubber compound in an adjacent portion of the tread which helps to render the tire more robust.

In one embodiment, the axially outer edge portion extends axially over 1% to 20%, preferably over 2% to 15%, of the total axial width of the tread. The axial width of the tread is determined herein in the tire in a cured state, wherein the total axial width of a tread is measured in a cross-section of the tire, perpendicular to the equatorial plane of the tire.

In another embodiment, the axially outer edge portion of the tread has an essentially triangular cross-section or shape (having three sides) in a plane perpendicular to the equatorial plane of the tire. Preferably, a first side of the axially outer edge portion contacts the neighboring portion of the tread, a second side covers at least one belt edge (preferably the axially outermost belt edge of the at least two belts), and/or a third side contacts (directly) the sidewall. In other words, the sidewall touches the axially outer edge portion of the tread and/or is cured to it. The axially outer edge portion touches also directly the neighboring portion of the tread. Typically, the axially outer edge portion has been extruded together with the remaining tread, in particular extruded together with the neighboring portion of the tread.

The axially outer edge portion may help to provide on the one hand a good connection of the sidewall touching the tread, and may help on the other hand to cover the belt edge.

In another embodiment, the second side covers the belt edge and one or more of a portion of the carcass and at least one overlay covering the belt edge. The belt edge may be covered also by two overlays or one or more overlay strips. Such strips may be circumferentially and/or spirally wound about the belts. Thus, the axially outer edge portion may protect the belt edges.

In still another embodiment, the neighboring portion (directly) contacts the axially outer edge portion.

In yet another embodiment, the neighboring portion is ground-contacting or intended to contact the ground or the road when the tire is one or more of cured, new and unworn.

In still another embodiment, the axially outer edge portion comprises or consists of a first rubber composition and the neighboring portion (preferably directly contacting the axially outer edge portion) comprises or consists of a second rubber composition, wherein the second rubber composition is different from the first rubber composition.

In still another embodiment, the axially outer edge portion comprises or consists of a first rubber composition and the neighboring portion (preferably directly contacting the axially outer edge portion) comprises or consists of a second rubber composition and the sidewall comprises or consists of a third rubber composition, wherein all three rubber compositions are preferably different from one another.

In still another embodiment, the axially outer edge portion comprises at least 25 phr, preferably at least 30 phr, or even more preferably at least 35 phr of a polybutadiene rubber, at least 30 phr, preferably at least 35 phr, of polyisoprene rubber (e.g. a synthetic polyisoprene rubber and/or natural rubber) and at least 20 phr of carbon black, preferably at least 30 phr of carbon black, or even more preferably at least 40 phr carbon black. Preferably, the axially outer edge portion has less than 90 phr of filler. In other words, the axially outer edge portion comprises or consists of a rubber composition having the above composition.

In still another embodiment, the sidewall comprises a rubber composition comprising at least 30 phr, preferably at least 35 phr, of a polybutadiene rubber, at least 30 phr, preferably at least 35 phr, of polyisoprene rubber (e.g. a synthetic polyisoprene rubber and/or natural rubber), and at least 20 phr of carbon black, preferably at least 30 phr of carbon black. Preferably, the rubber composition has less than 90 phr of filler. Therefore, the axially outer edge portion of the tread has a compositional similarity with the sidewall (or in other words sidewall component) composition. Preferably, despite similarity, the sidewall has nevertheless a different rubber composition than the axially outer edge portion.

In still another embodiment, the rubber composition of the sidewall and/or the axially outer edge portion comprises one or more tackifying resins, preferably selected from the list of phenol formaldehyde resins and alkylphenol acetylene resins.

In still another embodiment, the neighboring portion is a tread cap or tread cap portion.

In still another embodiment, the neighboring portion is a tread cap portion contacting the ground or the road when driving. In other words it is a neighboring tread cap portion.

In still another embodiment, the neighboring portion comprises at least one (or a) rubber composition comprising at least 90 phr of at one least a diene-based elastomer and at least 100 phr of filler. Preferably, the filler is within the range of 100 phr to 250 phr. In another embodiment, said filler comprises at least 40 phr of silica, preferably at least 90 phr of silica. Preferably, the rubber composition comprises 100 phr of at least one diene based elastomer. In an example, the rubber composition comprises 30 phr to 100 phr (or from 40 phr to 80 phr) of a hydrocarbon resin, preferably selected from the list of aliphatic (C5) resins, aromatic (C9) resins, cyclopentadiene resins, dicyclopentadiene resins, coumarone indene resins, terpene resins, styrene/a-methyl-styrene resins, terpene phenol resins, or combinations of those. Preferably the rubber composition comprises predominantly at least one styrene-butadiene rubber, such as at least one solution polymerized styrene-butadiene rubber. In another embodiment, said diene-based elastomer comprises at least 50 phr of styrene butadiene rubber. In general, the diene-based elastomers, such as the styrene-butadiene rubber or the solution polymerized-styrene butadiene rubber are preferably functionalized for the coupling to silica.

In another embodiment, the rubber composition of the neighboring portion comprises at least 150 phr of a filler comprising at least 90 phr of carbon black, preferably more than 100 phr of carbon black, as e.g. useful in UUHP or race tires.

In still another embodiment, the axially outer edge portion comprises or consists of a first rubber composition and the neighboring portion (preferably directly contacting the axially outer edge portion) comprises or consists of a second rubber composition, wherein the second rubber composition is different from the first rubber composition.

In yet another embodiment, the rubber composition of the sidewall and/or the axially outer edge portion has an elongation at break of at least 500%, preferably at least 550%, or even more preferably at least 600%. Elongation at break is determined by a ring sample test based on ASTM D412 or equivalent, wherein percentages are percentages of elongation. Such a relatively high elongation at break helps to provide a flexible area above the belt edges. It is also possible that the elongation at break is at most 800% or at most 700%.

In another embodiment, the rubber composition of at least one of (i) the sidewall and (ii) the axially outer edge portion has at least one of (a) an elongation at break of at least 500% (preferably of at least 550%), and (b) an elongation at break which is at least 5% higher (preferably 10% higher) than the elongation at break of the neighboring portion of the tread. 10% higher shall mean herein 10% higher relative to the (absolute) value of the elongation at break of the neighboring portion of the tread. As a non-limiting example, if an elongation at break of the neighboring portion of the tread is 480%, at least ten percent higher means at least 528% elongation at break for the axially outer edge portion of the tread.

In still another embodiment, the rubber composition of the sidewall and/or the axially outer edge portion have each a shore A hardness of less than 60, preferably less than 55 or even more preferably of less than 50. Shore A hardness is determined according to ASTM D2240 or equivalent herein.

In yet another embodiment, the shore A hardness of the rubber composition of the sidewall and/or the axially outer edge portion is within the range of 40 to 60, preferably within a range of 45 to 55.

In other words, the hardness of the rubber composition of the sidewall and the axially outer edge portion can be similarly low. In contrast a typical tread rubber compound would have a higher shore A hardness.

In another embodiment, the axially outer edge portion is one or more of: an axially outer cushion portion, an axially outer damping portion, an axially outer wedge-shaped portion, and an axially outer triangular portion. In addition or alternatively, it may be an axially outermost portion of the tread.

In another embodiment, the shore A hardness of the rubber composition of the neighboring portion of the tread is at least 55, preferably at least 60, or within a range of 55 to 75, preferably within a range of 60 and 75.

In another embodiment, the shore A hardness of the rubber composition of the axially outer edge portion is at least 5%, preferably at least 10%, or even more preferably at least 20%, lower than the shore A hardness of the neighboring tread portion.

In another embodiment, the storage modulus G′ of the rubber composition of the axially outer edge portion is within a range of 700 to 1700 kPa, preferably from 750 to 1500 kPa.

The storage modulus G′ is determined with a RPA 2000™ Rubber Process Analyzer of the company Alpha Technologies, based on ASTM D5289 (or equivalent) at 1% strain, 1 Hz and 100° C. The storage modulus can be considered as a stiffness indicator.

In another embodiment, the storage modulus G′ of the rubber composition of the axially outer edge portion is at least 5% lower, preferably at least 10% lower than the storage modulus G′ of the rubber composition of the neighboring tread portion.

In another embodiment, the storage modulus G′ of the rubber composition of the neighboring tread portion is within a range of 2000 to 10000 kPa, preferably from 2500 to 8000 kPa, or even more preferably from 3000 kPa to 7500 kPa.

Elongation at break, Shore A hardness and G′ are measured on cured rubber compositions, in particular of the cured tire.

In still another embodiment, the tire comprises one axially outer edge portion at each axial side of the tread (in other words two such portions in total), wherein optionally each axially outer edge portion is covered by a respective sidewall.

In still another embodiment, the axially outer edge portion and/or the neighboring tread portion are free of a fabric or wire reinforcement.

In still another embodiment, the axially outer edge portions do not touch each other and/or extend together over less than 30%, preferably less than 20%, or even more preferably over less ten 15%, of the total axial width of the tread. For example, the outer portions are not part of a tread base layer extending (e.g. radially below the tread) over the full width of the tread.

In still another embodiment, the belt edge is covered by one of (i) one or more overlays (or, in other words, an overlay ply) and (ii) one or more overlay strips. Overlays and overlay strips as such are known to the person skilled in the tire art. Such overlays or particularly overlay strips can be of advantage in higher performance tires.

In yet another embodiment, the sidewall extends over at least 80% of the radial height of the axially outer edge portion. Thus, the sidewall covers the side of the tread, in particular the axially outer edge portion of the tread. In many other constructions, a radially outer end of the sidewall, or in other words sidewall component or sidewall rubber component, is arranged or clamped between the tread and the carcass (sometimes referred to as sidewall under tread).

In still another embodiment, the axially outer edge portion covers i) at least an axially outer edge of a radially inner belt, ii) an axially outermost portion of the overlay or overlay strip and optionally iii) a carcass portion axially outwards the axially outermost portion of the overlay or overlay strip. In other words, the axially outermost portion covers and/or bridges the area between the axial end of the belt, axial end of the overlay or overlay strips and the carcass.

In yet another embodiment, the axially outer edge portion extends to a radially outermost position which is radially below the radially innermost surface of the tread in the equatorial plane of the tire (or in other words at the centerline of the tire).

In still another embodiment, the axially outer edge portion tapers in an axially outer and radially inner direction.

In still another embodiment, the neighboring portion (directly) contacts the axially outer edge portion.

The axially outer edge portion, the neighboring portion, the tread, the sidewalls, the belts, the overlays, the carcass, and other tire components typically also extend in the circumferential direction (around the tire).

In yet another embodiment, the sidewall tapers in its radially outermost portion and/or covers the majority of the axially outer edge portion. Preferably, the sidewall covers the axially outer edge portion such that it is not visible on the outer surface of the tire

In still another embodiment, the sidewall touches or contacts with its radially outermost portion the neighboring portion of the tread. Preferably, the neighboring portion of the tread contacts the road when driving.

In another embodiment, the axially outer edge portion is (covered) below the outer surface of the tire, preferably in a shoulder portion of the tire. In particular, it is not intended to contact the road upon driving or tire wear. It is preferably (e.g. radially) covered by the sidewall and optionally also the neighboring portion of the tread.

In still another embodiment, a radially outer side or surface of the axially outer edge portion extends essentially in or along the axial direction. Essentially includes herein angles of +/−10°, preferably +/−5°, with the same direction.

In yet another embodiment, the axially outer edge portion covers the axially outermost edge of the radially inner belt. An axially innermost end of the axially outer edge portion is provided between the axially outermost edge of the radially inner belt and the axially outermost edge of the radially outer belt.

In still another embodiment, the tire is a pneumatic tire or a non-pneumatic tire. Preferably, it is a pneumatic tire.

In still another embodiment, the tire may be a radial tire or a bias tire. Preferably, the tire is a radial tire.

In yet another embodiment, the tire is a tire having a speed symbol of “V”, “W” or “Y”, preferably “W” or “Y”. Such speed symbols are depicted on at least one sidewall of the tire.

In yet another embodiment, the tire is a summer tire.

In another embodiment, one or more rubber compositions mentioned herein may include at least one and/or one additional diene-based rubber. Representative synthetic polymers may be the homopolymerization products of butadiene and its homologues and derivatives, for example, methylbutadiene, dimethylbutadiene and pentadiene as well as copolymers such as those formed from butadiene or its homologues or derivatives with other unsaturated monomers. Among the latter may be acetylenes, for example, vinyl acetylene; olefins, for example, isobutylene, which copolymerizes with isoprene to form butyl rubber; vinyl compounds, for example, acrylic acid, acrylonitrile (which polymerize with butadiene to form NBR), methacrylic acid and styrene, the latter compound polymerizing with butadiene to form SBR, as well as vinyl esters and various unsaturated aldehydes, ketones and ethers, e.g. acrolein, methyl isopropenyl ketone and vinylethyl ether. Specific examples of synthetic rubbers include neoprene (polychloroprene), polybutadiene (including cis 1,4-polybutadiene), polyisoprene (including cis 1,4-polyisoprene), butyl rubber, halobutyl rubber such as chlorobutyl rubber or bromobutyl rubber, styrene/isoprene/butadiene rubber, copolymers of 1,3-butadiene or isoprene with monomers such as styrene, acrylonitrile and methyl methacrylate, as well as ethylene/propylene terpolymers, also known as ethylene/propylene/diene monomer (EPDM), and in particular, ethylene/propylene/dicyclopentadiene terpolymers. Additional examples of rubbers which may be used include alkoxy-silyl end functionalized solution polymerized polymers (SBR, PBR, IBR and SIBR), silicon-coupled and tin-coupled star-branched polymers. Preferred rubber or elastomers may be in general natural rubber, synthetic polyisoprene, polybutadiene and SBR including SSBR.

In an embodiment, a combination of two or more rubbers is preferred such as cis 1,4-polyisoprene rubber (natural or synthetic, although natural is preferred), 3,4-polyisoprene rubber, styrene/isoprene/butadiene rubber, emulsion and solution polymerization derived styrene/butadiene rubbers, cis 1,4-polybutadiene rubbers, and emulsion polymerization prepared butadiene/acrylonitrile copolymers.

In another embodiment, an emulsion polymerization derived styrene-butadiene rubber (ESBR) might be used having a styrene content of 20 to 28 percent bound styrene or, for some applications, an ESBR having a medium to relatively high bound styrene content, namely, a bound styrene content of 30 to 45 percent. In many cases the ESBR will have a bound styrene content which is within the range of 26 to 31 percent. By emulsion polymerization prepared ESBR, it may be meant that styrene and 1,3-butadiene are copolymerized as an aqueous emulsion. Such are well known to those skilled in such art. The bound styrene content can vary, for example, from 5 to 50 percent. In one aspect, the ESBR may also contain acrylonitrile to form a terpolymer rubber, as ESBAR, in amounts, for example, of 2 to 30 weight percent bound acrylonitrile in the terpolymer. Emulsion polymerization prepared styrene/butadiene/acrylonitrile copolymer rubbers containing 2 to 40 weight percent bound acrylonitrile in the copolymer may also be contemplated as diene-based rubbers.

In another embodiment, solution polymerization prepared SBR (SSBR) is used. Such an SSBR may for instance have a bound styrene content in a range of 5 to 50 percent, preferably 9 to 36 percent, and most preferably 26 to 31 percent. The SSBR can be conveniently prepared, for example, by anionic polymerization in an inert organic solvent. More specifically, the SSBR can be synthesized by copolymerizing styrene and a 1,3-butadiene monomer in a hydrocarbon solvent utilizing an organo lithium compound as the initiator. In still another embodiment, the solution styrene butadiene rubber is a tin-coupled polymer. In still another embodiment, the SSBR is functionalized for improved compatibility with silica. In addition, or alternatively, the SSBR is thio-functionalized. This helps to improve stiffness of the compound and/or its hysteresis behavior. Thus, for instance, the SSBR may be a thio-functionalized, tin-coupled solution polymerized copolymer of butadiene and styrene.

In one embodiment, a synthetic or natural polyisoprene rubber is used. Synthetic cis-1,4-polyisoprene and natural rubber are as such well known to those having skill in the rubber art. In particular, the cis 1,4-microstructure content may be at least 90% and is typically at least 95% or even higher.

In one embodiment, cis-1,4-polybutadiene rubber (BR or PBD) is used. Suitable polybutadiene rubbers may be prepared, for example, by organic solution polymerization of 1,3-butadiene. The BR may be conveniently characterized, for example, by having at least a 90 percent cis-1,4-microstructure content (“high cis” content) and a glass transition temperature (Tg) in a range of from −95° C. to −110° C. Suitable polybutadiene rubbers are available commercially, such as Budene® 1207, Budene® 1208, Budene® 1223, or Budene® 1280 from The Goodyear Tire & Rubber Company. These high cis-1,4-polybutadiene rubbers can for instance be synthesized utilizing nickel catalyst systems which include a mixture of (1) an organonickel compound, (2) an organoaluminum compound, and (3) a fluorine containing compound as described in U.S. Pat. Nos. 5,698,643 and 5,451,646, which are incorporated herein by reference.

A glass transition temperature, or Tg, of an elastomer or elastomer/rubber composition, where referred to herein, represents the glass transition temperature(s) of the respective elastomer or elastomer composition in its uncured state or possibly a cured state in the case of an elastomer composition. A Tg can be suitably determined by the midpoint or inflection point of the step observed in association with the glass transition, as measured using a differential scanning calorimeter (DSC) at a temperature change rate of 10° C. per minute, according to ASTM D3418.

The term “phr” as used herein, and according to conventional practice, refers to “parts by weight of a respective material per 100 parts by weight of rubber, or elastomer”. In general, using this convention, a rubber composition is comprised of 100 parts by weight of rubber/elastomer. The claimed composition may comprise other rubbers/elastomers than explicitly mentioned in the claims, provided that the phr value of the claimed rubbers/elastomers is in accordance with claimed phr ranges and the amount of all rubbers/elastomers in the composition results in total in 100 parts of rubber. In an example, the composition may further comprise from 1 phr to 10 phr, optionally from 1 phr to 5 phr, of one or more additional diene-based rubbers, such as SBR, SSBR, ESBR, PBD/BR, NR and/or synthetic polyisoprene. In another example, the composition may include less than 5, preferably less than 3, phr of an additional diene-based rubber or be also essentially free of such an additional diene-based rubber. The terms “compound” and “composition” and “formulation” may be used herein interchangeably, unless indicated otherwise.

In an embodiment, the rubber composition may also include one or more additional oils, in particular (additional) processing oils. Processing oil may be included in the rubber composition as extending oil typically used to extend elastomers. Processing oil may also be included in the rubber composition by addition of the oil directly during rubber compounding. The processing oil used may include both extending oil present in the elastomers, and process oil added during compounding. Suitable process oils may include various oils as are known in the art, including aromatic, paraffinic, naphthenic, vegetable oils, and low PCA oils, such as MES, TDAE, SRAE and heavy naphthenic oils. Suitable low PCA oils may include those having a polycyclic aromatic (PCA) content of less than 3 percent by weight as determined by the IP346 method. Procedures for the IP346 method may be found in Standard Methods for Analysis & Testing of Petroleum and Related Products and British Standard 2000 Parts, 2003, 62nd edition, published by the Institute of Petroleum, United Kingdom. Some representative examples of (non-aminated and non-epoxidized) vegetable oils that can be used include soybean oil, sunflower oil, canola (rapeseed) oil, corn oil, coconut oil, cottonseed oil, olive oil, palm oil, peanut oil, and safflower oil.

In an embodiment, the rubber composition includes silica. Commonly employed siliceous pigments which may be used in the rubber compound include for instance conventional pyrogenic and precipitated siliceous pigments (silica). In one embodiment, precipitated silica is used. The conventional siliceous pigments may be precipitated silicas such as, for example, those obtained by the acidification of a soluble silicate, e.g., sodium silicate. Such conventional silicas might be characterized, for example, by having a BET surface area, as measured using nitrogen gas. In one embodiment, the BET surface area may be in the range of 40 to 600 square meters per gram. In another embodiment, the BET surface area may be in a range of 50 to 300 square meters per gram. The BET surface area is determined herein according to ASTM D5604-96 or equivalent. The conventional silica may also be characterized by having a dibutylphthalate (DBP) absorption value in a range of 100 cm³/100 g to 400 cm³/100 g, alternatively 150 cm³/100 g to 300 cm³/100 g which can be suitably determined according to ASTM D 2414 or equivalent. Various commercially available silicas may be used, such as, only for example herein, and without limitation, silicas commercially available from PPG Industries under the Hi-Sil trademark with designations 210, 315G, EZ160G, etc.; silicas available from Solvay, with, for example, designations ZeoSil 1165 MP and ZeoSil Premium 200 MP, etc.; and silicas available from Evonik AG with, for example, designations VN2 and Ultrasil 6000GR, 9100GR, etc.

In an embodiment, the rubber composition may include carbon black. Representative examples of such carbon blacks include N110, N121, N134, N220, N231, N234, N242, N293, N299, N315, N326, N330, N332, N339, N343, N347, N351, N358, N375, N539, N550, N582, N630, N642, N650, N683, N754, N762, N765, N774, N787, N907, N908, N990 and N991 grades. These carbon blacks have iodine absorptions ranging from 9 g/kg to 145 g/kg and a DBP number ranging from 34 cm³/100 g to 150 cm³/100 g. Iodine absorption values can be suitably determined according to ASTM D1510 or equivalent. Commonly employed carbon blacks can be used as a conventional filler in an amount ranging from 10 phr to 150 phr. However, in a preferred embodiment the composition comprises at most 10 phr of carbon black, preferably at most 5 phr of carbon black, as preferred embodiments are directed to high silica compounds and the improvement of their properties.

In another embodiment, other fillers may be used in the rubber composition including, but not limited to, particulate fillers including ultra high molecular weight polyethylene (UHMWPE), crosslinked particulate polymer gels including but not limited to those disclosed in U.S. Pat. Nos. 6,242,534, 6,207,757, 6,133,364, 6,372,857, 5,395,891, or 6,127,488, and a plasticized starch composite filler including but not limited to that disclosed in U.S. Pat. No. 5,672,639. The teachings of U.S. Pat. Nos. 6,242,534, 6,207,757, 6,133,364, 6,372,857, 5,395,891, 6,127,488, and 5,672,639 are incorporated herein by reference. Syndiotactic polybutadiene may also be utilized. Other reinforcing fillers may be used in an amount ranging from 1 phr to 30 phr.

In one embodiment, the rubber composition may contain a conventional sulfur containing organosilicon compounds or silanes. Examples of suitable sulfur containing organosilicon compounds are of the formula:

Z-Alk-Sn-Alk-Z I

in which Z is selected from the group consisting of

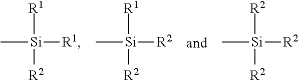

where R¹ is an alkyl group of 1 to 4 carbon atoms, cyclohexyl or phenyl; R² is an alkoxy of 1 to 8 carbon atoms, or cycloalkoxy of 5 to 8 carbon atoms; Alk is a divalent hydrocarbon of 1 to 18 carbon atoms and n is an integer of 2 to 8. In one embodiment, the sulfur containing organosilicon compounds are the 3,3′-bis(trimethoxy or triethoxy silylpropyl) polysulfides. In one embodiment, the sulfur containing organosilicon compounds are 3,3′-bis(triethoxysilylpropyl) disulfide and/or 3,3′-bis(triethoxysilylpropyl) tetrasulfide. Therefore, as to formula I, Z may be

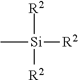

where R² is an alkoxy of 2 to 4 carbon atoms, alternatively 2 carbon atoms; Alk is a divalent hydrocarbon of 2 to 4 carbon atoms, alternatively of 3 carbon atoms; and n is an integer of from 2 to 5, alternatively 2 or 4. In another embodiment, suitable sulfur containing organosilicon compounds include compounds disclosed in U.S. Pat. No. 6,608,125. In one embodiment, the sulfur containing organosilicon compounds includes 3-(octanoylthio)-1-propyltriethoxysilane, CH₃(CH₂)₆C(═O)—S—CH₂CH₂CH₂Si(OCH₂CH₃)₃, which is available commercially as NXT™ from Momentive Performance Materials. In another embodiment, suitable sulfur containing organosilicon compounds include those disclosed in United States Patent Application Publication No. 2003/0130535. In one embodiment, the sulfur containing organosilicon compound is Si-363 from Degussa. The amount of the sulfur containing organosilicon compound in a rubber composition may vary depending on the level of other additives that are used. Generally speaking, the amount of the compound may range from 0.5 phr to 20 phr. In one embodiment, the amount will range from 1 phr to 10 phr.

In another embodiment, the rubber composition comprises less than 0.1 phr of cobalt salt or 0 phr of cobalt salt.

It is readily understood by those having skill in the art that the rubber composition(s) may be compounded by methods generally known in the rubber compounding art, such as mixing the various sulfur-vulcanizable constituent rubbers with various commonly used additive materials such as, for example, sulfur donors, curing aids, such as activators and retarders and processing additives, such as oils, resins including tackifying resins and plasticizers, fillers, pigments, fatty acid, zinc oxide, waxes, antioxidants, antiozonants and peptizing agents. As known to those skilled in the art, depending on the intended use of the sulfur vulcanizable and sulfur-vulcanized material (rubbers), the additives mentioned above are selected and commonly used in conventional amounts. Some representative examples of sulfur donors include elemental sulfur (free sulfur), an amine disulfide, polymeric polysulfide and sulfur olefin adducts. In one embodiment, the sulfur-vulcanizing agent is elemental sulfur. The sulfur-vulcanizing agent may for instance be used in an amount ranging from 0.5 phr to 8 phr, alternatively with a range of from 1.5 phr to 6 phr. Typical amounts of tackifier resins, if used, comprise for example 0.5 phr to 10 phr, usually 1 phr to 5 phr. Typical amounts of processing aids, if used, comprise for example 1 phr to 50 phr (this may comprise in particular oil). Typical amounts of antioxidants, if used, may for example comprise 1 phr to 5 phr. Representative antioxidants may be, for example, diphenyl-p-phenylenediamine and others, such as, for example, those disclosed in The Vanderbilt Rubber Handbook (1978), Pages 344 through 346. Typical amounts of antiozonants, if used, may for instance comprise 1 phr to 5 phr. Typical amounts of fatty acids, if used, which can include stearic acid, may for instance comprise 0.5 phr to 3 phr. Typical amounts of waxes, if used, are normally employed at a level which is within the range of 1 phr to 5 phr. Often microcrystalline waxes are used. Typical amounts of peptizers, if used, are normally within the range of 0.1 phr to 1 phr. Typical peptizers may be, for example, pentachlorothiophenol and/or dibenzamidodiphenyl disulfide.

Accelerators may be preferably but not necessarily used to control the time and/or temperature required for vulcanization and to improve the properties of the vulcanizate. In one embodiment, a single accelerator system may be used, i.e. primary accelerator. The primary accelerator(s) may be used in total amounts ranging from 0.5 phr to 4 phr, alternatively 0.8 phr to 1.5 phr. In another embodiment, combinations of a primary and a secondary accelerator might be used with the secondary accelerator being used in smaller amounts, such as from 0.05 phr to 3 phr, in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are for instance amines, disulfides, guanidines, thioureas, thiazoles, thiurams, sulfenamides, dithiocarbamates and xanthates. In one embodiment, the primary accelerator is a sulfenamide. If a second accelerator is used, the secondary accelerator may be for instance a guanidine, dithiocarbamate or thiuram compound. Suitable guanidines include dipheynylguanidine and the like. Suitable thiurams include tetramethylthiuram disulfide, tetraethylthiuram disulfide, and tetrabenzylthiuram disulfide.

The mixing of the rubber composition can be accomplished by methods known to those having skill in the rubber mixing art. For example, the ingredients may be typically mixed in at least two stages, namely, at least one nonproductive stage followed by a productive mix stage. The final curatives including sulfur-vulcanizing agents may be typically mixed in the final stage which is conventionally called the “productive” mix stage in which the mixing typically occurs at a temperature, or ultimate temperature, lower than the mix temperature(s) of the preceding nonproductive mix stage(s). The terms “nonproductive” and “productive” mix stages are well known to those having skill in the rubber mixing art. In an embodiment, the rubber composition may be subjected to a thermomechanical mixing step. The thermomechanical mixing step generally comprises a mechanical working in a mixer or extruder for a period of time, for example suitable to produce a rubber temperature between 140° C. and 190° C. The appropriate duration of the thermomechanical working varies as a function of the operating conditions, and the volume and nature of the components. For example, the thermomechanical working may be from 1 to 20 minutes.

In another embodiment the tire has a tread with one or more tread cap layers. In such an embodiment, the axially outer edge portion or outermost portion can extend essentially perpendicular to the tread cap layers and/or beside the tread cap layers. If the tread has a tread base, the axially outer edge portion, preferably also extends perpendicular to the tread base and/or beside the tread base.

Vulcanization of the pneumatic tire of the present invention may for instance be carried out at conventional temperatures ranging from 100° C. to 200° C. In one embodiment, the vulcanization is conducted at temperatures ranging from 110° C. to 180° C. Any of the usual vulcanization processes may be used such as heating in a press or mold, heating with superheated steam or hot air. However, it is generally preferred for the tires of this invention to be cured at a temperature ranging from about 132° C. (270° F.) to about 166° C. (330° F.). It is more typical for the tires of this invention to be cured at a temperature ranging from 143° C. (290° F.) to 154° C. (310° F.). Such tires can be built, shaped, molded and cured by various methods which are known and are readily apparent to those having skill in such art.

In another aspect, a method of building a tire is provided, preferably the tire according to the aforementioned aspect(s) and or the respective embodiments, the method comprising at least the steps of:

a) extruding a tread comprising at least one axially outer edge portion and a portion neighboring, and preferably contacting, the axially outer edge portion;

b) providing a carcass with (attached) belts and optionally one or more overlays or overlay strips;

c) attaching the tread to the carcass so as to cover the belts or optionally the one or more overlays or overlays strips;

d) attaching two sidewalls to the carcass and (partially) over the axial edges of the tread;

d) optionally, shaping the tire; and

e) curing the tire.

In general, all of the above aspects, embodiments and features thereof may be combined with one another.

### BRIEF DESCRIPTION OF THE DRAWINGS

The structure, operation, and advantages of the invention will become more apparent upon contemplation of the following description taken in conjunction with the accompanying drawings, wherein

FIG. 1 is a schematic cross-section of a crown portion of a prior art tire; and wherein

FIG. 2 is a schematic cross-section of a crown portion of a tire in accordance with an embodiment of the invention.

### DETAILED DESCRIPTION OF THE INVENTION

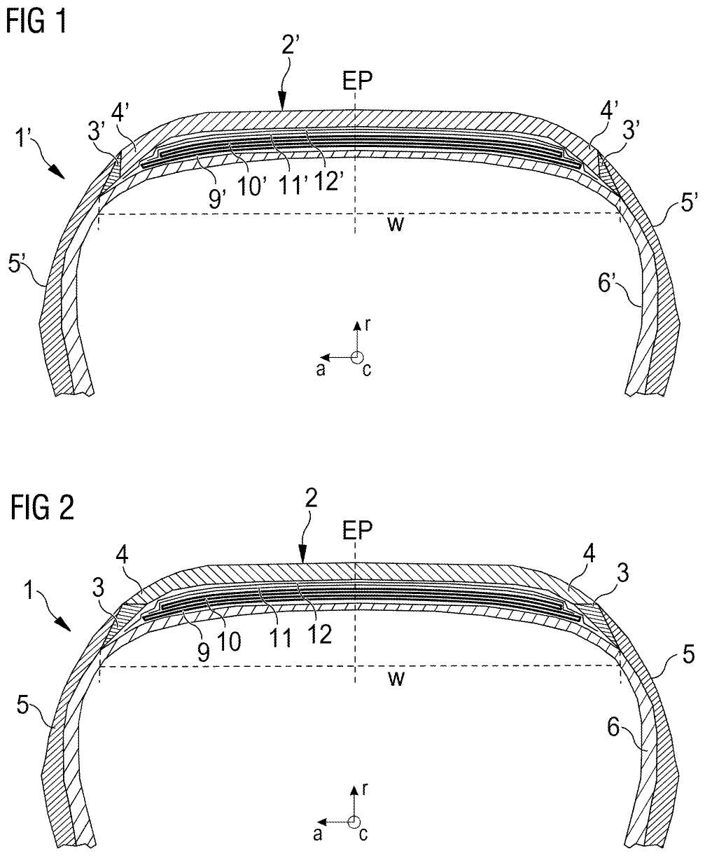

FIG. 1 is a schematic cross-section of a tire 1′ (not entirely in accordance with the present invention). The tire has a plurality of tire components including a tread 2′, two sidewalls 5′, a carcass 6′, two belts 9′, 10′ and two overlay layers or overlays 11′, 12′.

The tire 1′ depicted in FIG. 1 has two belts 9′, 10′ as for instance typically present in passenger cars. Usually, each belt 9′, 10′ has a metallic reinforcement. A radially inner belt 9′ is broader than the radially outer belt 10′, with respect to the axial direction (a) of the tire 1′.

A first radially inner overlay 12′ extends axially over an axial width covering the axial outer edges of the radially outer belt 10′ but not the edges of the radially inner belt 9′.

A second radially outer overlay 11′ extends over an axial width larger than that of the radially inner belt 9′ so as to cover the belt edge of the radially inner belt 9′ and also the belt edge of the radially outer belt 10′.

The tread 2′ comprises a so-called wing portion or axially outer edge portion 3′ which is attached to or in contact with a neighboring tread portion 4′. The tread 2′ has a total width w measured in the axial direction a, which is perpendicular to the equatorial plane (EP) of the tire 1′. The axially outer edge portion 3′ may help to improve the bond between sidewall 5′ and tread 2′, especially with the neighboring tread portion 4′. In particular, the sidewalls 5′ are laid over or cover the respective axially outer edge portion 3′ of the tread 2′. Moreover, the sidewalls 5′ cover the carcass 6′ at the axially outer sides of the tire 1′. Such a configuration is also sometimes referred to as sidewall over tread (SOT), in contrast to tread over sidewall (TOS). As visible in FIG. 1, the axially outer edge portion 3′ does not cover one or more of the belts 9′, 10′or is, in other words, axially spaced from the belts 9′, 10′. Rather the belts are completely covered below the neighboring tread portion 4′, which is a tread portion or tread cap portion that contacts also the ground or road when driving. In other words, the portion 4′ is intended to contact the road when driving, whereas the axially outer edge portion 3′ is not intended to contact the ground when driving.

The tread 2′ is schematically depicted without grooves but may have one or more circumferential grooves, e.g. delimiting one or more circumferential ribs or rows of tread blocks of the tire (not shown).

In general, a tire 1′ as depicted in FIG. 1 may have also two opposite bead portions, including apexes and potentially further components in the bead portions which are not depicted as they are not deemed relevant in the context of the present invention. In general such a tire may have further components not depicted herein.

The axial direction a, the radial direction r, and the circumferential direction c are shown for a better intelligibility in FIGS. 1 and 2. It is emphasized that the word direction is not limited as such to a certain orientation unless described otherwise herein.

One or more of the depicted components, such as the carcass, belts and overlays, may be fiber and/or fabric reinforced, either with metallic or textile reinforcements.

FIG. 2 depicts an embodiment of the present invention, in which different components are described with reference signs corresponding to those of FIG. 1. Thus, the tire 1 of FIG. 2 has also a tread 2 having axially outer edge portions 3 and a neighboring tread portion 4, two sidewalls 5, a carcass 6, two belts 9, 10 and two overlays 11, 12. The tread has the total axial width w measured between its actually outermost edges. It is noted that such a measurement can be carried out on a cross section of a tire along the axial direction. Axial direction is understood as directions in parallel to the direction of the axis of rotation of the tire. A radial direction is a direction perpendicular to the axis of rotation of the tire.

A main difference between the tire 1′ shown in FIG. 1 and the tire 1 shown in FIG. 2 consists in that the axially outer edge portion 3 of tire 1 covers the axially outer edge of one of the belts (i.e. herein the axially outer edge of the radially inner belt 9). In other words, the axially outer edge portion 3 of the tread 2 extends to an axially inner position which is axially closer to the equatorial plane EP of the tire 1 than the axially outer edge of the radially inner belt 9. At the same time, the axially outer edge portion 3 covers also the axially outer end of the radially outer overlay 12. In this non-limiting embodiment, the axially outer edge portion 3 may also be described as wedge-shaped portion or has in other words a wedge-shaped or essentially triangular cross-section in a plane perpendicular to the equatorial plane EP of the tire 1.

The sidewall 5 of the tire 1 covers the axially outer edge portion 3 of the tread 2 or is, in other words, laid upon or over the tread 2 and the axially outer edge portion 3.

The remaining components could have the shape, properties, or function as already described herein above in relation to FIG. 1.

In a preferred embodiment, the axially outer edge portion 3 of the tread 4 comprises a rubber composition which is similar to that of the sidewall. For instance it may comprise from 30 phr to 70 phr of polyisoprene, 30 phr to 70 phr of polybutadiene and from 30 phr to 80 phr of carbon black as filler material. This would typically not be a rubber composition which is used for a tread portion intended to contact a road. At the same time, the sidewall may comprise a rubber composition having the same or a similar rubber composition comprising from 30 phr to 70 phr of polyisoprene, 30 phr to 70 phr of polybutadiene and from 30 phr to 80 phr of carbon black as filler material.

The tread 2 is depicted with only 3 portions, i.e. two axially outer edge portions 3 and a central portion or in other words the neighboring portion 4. In principle, it is possible that the central portion comprises multiple tread portions such as in a (vertical) split tread design, i.e. having at least two strips comprising different rubber compounds axially beside one another, or in other words vertically split. It is also possible, in another embodiment, to provide a tread cap with multiple horizontal (or axial) splits, e.g. multiple tread cap layers arranged radially on top of each other. In such an embodiment (not shown), the neighboring portion would be the radially outermost portion or radially outermost layer of the tread or tread cap as it is intended to contact the road when driving. Preferably, as shown in FIG. 2, the neighboring portion 4 directly contacts the axially outer edge portion 3.

In an embodiment, a central tread portion and/or the neighboring portion 4 of the tread 2 may comprise a rubber composition comprising 100 phr of a diene-based elastomer and 100 phr to 250 phr of a filler, preferably comprising at least 40 phr of silica. Moreover, the rubber composition of the neighboring portion may comprise one or more traction resins or resins as listed already herein above. Preferably, the majority of the diene-based elastomer is at least one (preferably solution-polymerized) styrene-butadiene rubber, being optionally functionalized for the coupling to silica. The axially outer edge portion 3 has in the example a higher elongation at break than the neighboring portion of the tread 4 and preferably also a lower Shore A hardness and/or lower storage modulus G′ which can be considered as a stiffness indicator. This is considered to provide an improved flexibility in the area covering the belt edge, in particular the radially inner belt's edge.

The inventors have also carried out FEA simulations for tires having designs as shown in FIG. 1 and FIG. 2 which have shown an improved endurance of the design according to FIG. 2. In particular, the areas of the axially outermost belt edges did not heat up as much as in the design according to FIG. 1 when simulating the design of FIG. 2.

In particular, the present sidewall over tread construction according to FIG. 1 may result in a reduced endurance compared to a sidewall under tread construction as it has less flexible or soft material between the tread and the belt edge. According to a non-binding theory of the inventors, the enlarged axially outer edge portion 3 of the tread 2 according to FIG. 2 helps to exert less stress on the belt edges (compared to the design according to FIG. 1) which results in a reduced heat generation and limits the risk of failures.

Moreover, test tires have been built for each design as shown in FIG. 1 (prior art) and FIG. 2 (embodiment of the invention) in the size 255/35 ZR 20. An endurance test over more than ten thousand kilometers and under high load was run. This test confirmed the FEA results in that the design according to FIG. 2 did not show failures in the belt edge area.

While certain representative embodiments and details have been shown for the purpose of illustrating the subject invention, it will be apparent to those skilled in this art that various changes and modifications can be made therein without departing from the scope of the subject invention.

What is claimed is:

1. A tire comprising a tread, sidewalls, a carcass and at least two belts arranged radially between the carcass and the tread in a crown area of the tire,
wherein the tread has at least one axially outer edge portion radially covering an axially outermost edge of at least one of the belts and comprising a different rubber composition than a neighboring portion of the tread, wherein the neighboring portion is adapted to be ground-contacting, and
wherein one of the sidewalls at least partially covers and contacts an axially outer surface of the axially outer edge portion of the tread.

2. The tire according to claim 1, wherein the axially outer edge portion extends axially over 1% to 20% of the total width of the tread.

3. The tire according to claim 1, wherein the axially outer edge portion has an essentially triangular cross-section in a plane perpendicular to the equatorial plane of the tire, wherein a first side of the essentially triangular cross-section contacts the neighboring portion of the tread, a second side of the essentially triangular cross-section covers the axially outermost edge of at least one of the belts, and a third side of the essentially triangular cross-section contacts the sidewall.

4. The tire according to claim 3, wherein the second side further covers one or more of a portion of the carcass and at least one overlay covers the axially outermost edge of at least one of the belts.

5. The tire according to claim 1, wherein the axially outer edge portion comprises a rubber composition comprising at least 30 phr of polybutadiene rubber, at least 30 phr of polyisoprene rubber, and at least 20 phr of carbon black.

6. The tire according to claim 5, wherein the sidewall comprises a rubber composition comprising at least 30 phr of a polybutadiene rubber, at least 30 phr of polyisoprene rubber, and at least 20 phr of carbon black.

7. The tire according to claim 5, wherein the neighboring portion comprises a rubber composition comprising at least 50 phr of at least one styrene-butadiene rubber and at least 100 phr of filler.

8. The tire according to claim 1,
wherein a rubber composition of at least one of (i) the sidewall and (ii) the axially outer edge portion has at least one of:
(a) an elongation at break of at least 500%, and (b) an elongation at break which is at least 10% higher than the elongation at break of a rubber composition of the neighboring portion of the tread.

9. The tire according to claim 1, wherein a rubber composition of at least one of (i) the sidewall and (ii) the axially outer edge portion has at least one of:
(a) a Shore A hardness of less than 55, and (b) a Shore A hardness which is at least 5% lower than the Shore A hardness of a rubber composition of the neighboring portion of the tread.

10. The tire according to claim 1, comprising one axially outer edge portion at each axial side of the tread, wherein each axially outer edge portion is covered by a respective sidewall.

11. The tire according to claim 10, wherein the axially outer edge portions do not touch each other and extend together over less than 20% of the total width of the tread.

12. The tire according to claim 1, wherein said belt edge is covered by at least one of an overlay and one or more overlay strips.

13. The tire according to claim 1, wherein the sidewall extends over at least 80% of the radial height of the axially outer edge portion.

14. The tire according to claim 12, wherein the axially outer edge portion covers (i) at least an axially outer edge of a radially inner belt, (ii) an axially outermost portion of the overlay or overlay strips, and optionally (iii) a carcass portion axially outwards the axially outermost portion of the overlay or overlay strips.

15. The tire according to claim 1, wherein the axially outer edge portion extends to a radially outermost position which is radially below the radially innermost surface of the tread in the equatorial plane of the tire.

16. The tire according to claim 1, wherein the axially outer edge portion tapers in an axially outer and radially inner direction.

17. The tire according to claim 1, wherein the sidewall tapers in its radially outermost portion and covers the majority of the axially outer surface of the axially outer edge portion.

18. The tire according to claim 1, wherein the sidewall contacts with its radially outermost portion the neighboring portion of the tread.

19. The tire according to claim 1, wherein a radially outer surface of the axially outer edge portion extends essentially in an axial direction.

20. The tire according to claim 1, wherein an axially innermost end of the axially outer edge portion is situated between the axially outermost edge of the radially inner belt and the axially outermost edge of the radially outer belt.
